(19) United States
(12) Patent Application Publication
(10) Pub. No.: US 2026/0303600 A1
(43) Pub. Date: Oct. 1, 2026

(54) Authorization of Data Access via Data Collection Coordination Function (DCCF)

(71) Applicant: Telefonaktiebolaget LM Ericsson (publ), Stockholm (SE)

(72) Inventors: Christine Jost, Dalby (SE); Cheng Wang, Shanghai (CN); Yunjie Lu, Shanghai (CN); Songmao Li, Shanghai (CN); Dan Xu, Göteborg (SE)

(21) Appl. No.: 19/478,082

(22) PCT Filed: Mar. 21, 2024
(86) PCT No.: PCT/EP2024/057564

§ 371 Date: Oct. 23, 2025

(30) Foreign Application Priority Data
May 2, 2023 (WO) PCT/CN2023/091938

(51) Int. Cl. H04L 9/40

(52) U.S. Cl. CPC H04L 63/10; H04L 63/083

(57) ABSTRACT

Embodiments include methods performed by a data collection coordination function (DCCF) of a communication network. Such methods include receiving from a service consumer network function (NFc) a first service request for data and determining a service producer network function (NFp) that produces the data. Such methods include sending to a network repository function (NRF) a request for a second access token granting DCCF permission to access the data on behalf of NFc. The request includes client credentials assertion (CCA) associated with one of DCCF and NFc, and additional credentials assertion (ACA) associated with the other of DCCF and NFc. Such methods include receiving from the NRF the second access token, including subject claim identifying one of DCCF and NFc and additional claim identifying the other of DCCF and NFc. Such methods include sending to the NFp a second service request including the second access token, the CCA, and the ACA.

### TECHNICAL FIELD

The present disclosure relates generally to the field of communication networks, and more specifically to techniques for authorization of network functions (NFs) to collect and/or consume data produced by other NFs in a communication network.

### Introduction

The fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. 5G was initially standardized in 3GPP Rel-15 and continues to evolve through subsequent releases.

At a high level, the 5G System (5GS) consists of an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

FIG. 1 illustrates a high-level view of an exemplary 5G network architecture, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces (e.g., 140 between gNBs 100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such as controlling the operation of DUs. In contrast, DUs (e.g., 120, 130) are decentralized logical nodes that host lower layer protocols and can include, depending on the functional split option, various subsets of gNB functions. A CU connects to one or more DUs over respective F1 logical interfaces (e.g., 122, 132 in FIG. 1).

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

The 5G SBA model is based on principles including modularity, reusability, and self-containment of NFs, which can enable network deployments to take advantage of the latest virtualization and software technologies. In the 5G SBA, network repository functions (NRF) allow every network function to discover the services offered by other network functions, and Data Storage Functions (DSF) allow every network function to store its context.

The NFs in the 5GC SBA can communicate with each other directly or indirectly. Indirect communication between an NF acting as service consumer and NF acting as service producers involves a Service Communication Proxy (SCP). Both types of communication can use authentication for security. For direct communication, authentication between NFs and/or NRF within a single public land mobile network (PLMN) can be based on Transport Layer Security (e.g., TLS) or may be implicit based on lower layer security (NDS/IP/physical) if TLS is unavailable. For indirect communication, authentication can also be based on Client Credentials Assertion (CCA), a token signed by a NF Service Consumer that is included in a service request towards a receiving end point (e.g., NRF or NF Service Producer). 3GPP TS 33.501 (v17.9.0) section 13.3.8 describes CCA in more detail.

3GPP Rel-17 enhances SBA by adding a Data Management Framework that includes a Data Collection Coordination Function (DCCF) and a messaging framework, which are defined in detail in 3GPP TS 23.288 (v17.8.0). Data consumers ask DCCF for data collection in relation to a data producer. DCCF subscribes to the data producer (if not already subscribed), then coordinates the request and data delivery using the messaging framework. The data producer inputs the requested data to the messaging framework, which delivers the data to the data consumer.

### SUMMARY

However, there are various problems, issues, and/or difficulties when using CCA for authentication for data access via DCCF using indirect communication via SCP. For example, an access token request may need to identify both NF service consumer (NFc) and the DCCF, which may not be possible in current message structure. As another example, since the DCCF makes a service request on behalf of NFc in this model, the service request also may need to carry the CCA of the DCCF. This may not be possible in the current message structure. Moreover, even if multiple CCAs (i.e., NFc, DCCF) were present in the service request, the NF service producer (NFp) currently has no way to determine which NF is authenticated and linked with specific claim(s) in the access token (e.g., subject claim, source NF claim).

An object of embodiments of the present disclosure is to address scenarios in which more than one NF needs to be authenticated to a receiving NF (e.g., NRF or NFp), thereby allowing the receiving NF to determine which authenticated NF is linked to a which claim(s) in an access token, thereby enabling otherwise-advantageous deployment of DCCF-based communication in 5G networks.

Some embodiments include methods (e.g., procedures) performed by a DCCF of a communication network (e.g., 5GC).

These exemplary methods include receiving, from a service consumer network function (NFc) of the communication network, a first service request for data produced by the communication network. These exemplary methods also include determining a service producer network function (NFp), of the communication network, that produces the requested data. These exemplary methods also include sending, to an NRF of the communication network, a request for a second access token granting the DCCF permission to access the data produced by the NFp on behalf of the NFc. The request includes a client credentials assertion (CCA) associated with one of the DCCF and the NFc, and an additional credentials assertion (ACA) associated with the other of the DCCF and the NFc.

These exemplary methods also include receiving the second access token from the NRF. The second access token includes a subject claim identifying one of the DCCF and the NFc and an additional claim identifying the other of the DCCF and the NFc. These exemplary methods also include sending to the NFp a second service request for the data. The second service request includes the second access token, the CCA, and the ACA.

In some embodiments, the first service request also includes a first CCA associated with the NFc. In some of these embodiments, the CCA is associated with the DCCF, the ACA is associated with the NFc, the ACA includes the first CCA received in the first service request, the subject claim identifies the DCCF, and the additional claim identifies the NFc. FIG. 6 shows an example of these embodiments.

In other embodiments, the CCA is associated with the NFc, the ACA is associated with the DCCF, the CCA includes the first CCA received in the first service request, the subject claim identifies the NFc, and the additional claim identifies the DCCF. FIG. 7 shows an example of these embodiments.

In some embodiments, sending the request for the second access token is performed selectively according to one or more of the following: NRF support of authorization based on CCA and ACA, and local configuration of the DCCF. In such embodiments, when sending the request for the second access token is not performed, these exemplary methods include performing a local authorization for the NFc to access the data produced by the NFp.

Other embodiments include methods (e.g., procedures) performed by an NRF of a communication network.

These exemplary methods include receiving, from a DCCF of the communication network, a second request for a second access token granting the DCCF permission to access, on behalf of a service consumer network function (NFc) of the communication network, data produced by a service producer network function (NFp) of the communication network. The second request includes a client credentials assertion (CCA) associated with one of the DCCF and the NFc and an additional credentials assertion (ACA) associated with the other of the DCCF and the NFc.

These exemplary methods also include, based on the CCA and ACA, verifying that the DCCF is authorized to access the data produced by the NFp on behalf of the NFc. These exemplary methods also include, based on verifying that the DCCF is authorized to access the data, generating the second access token and sending to the DCCF a second response that includes the second access token. The second access token includes a subject claim identifying one of the DCCF and the NFc and an additional claim identifying the other of the DCCF and the NFc.

In some embodiments, the CCA is associated with the DCCF and the ACA is associated with the NFc, the ACA includes a first CCA associated with the NFc, and the subject claim identifies the DCCF and the additional claim identifies the NFc. In other embodiments, the CCA is associated with the NFc and the ACA is associated with the DCCF, and the subject claim identifies the NFc and the additional claim identifies the DCCF.

Other embodiments include methods (e.g., procedures) performed by a service producer NF (NFp) of a communication network (e.g., 5GC).

These exemplary methods can include receiving, from a DCCF of the communication network, a second service request for data produced by the NFp. The second service request includes a second access token granting the DCCF permission to access the data on behalf of a service consumer network function (NFc) of the communication network. The second access token includes a subject claim identifying one of the DCCF and the NFc and an additional claim identifying the other of the DCCF and the NFc. These exemplary methods also include verifying the second access token and based on verifying the second access token, sending to the DCCF a service response that includes the data.

In some embodiments, the second service request also includes a CCA associated with the one of the DCCF and the NFc, and an ACA associated with the other of the DCCF and the NFc. In some of these embodiments, verifying the second access token includes verifying that the identification in the subject claim matches the CCA and that the identification in the additional claim matches the ACA.

In some of these embodiments, the CCA is associated with the DCCF, the ACA is associated with the NFc, the ACA includes the first CCA received in the first service request, the subject claim identifies the DCCF, and the additional claim identifies the NFc. In other embodiments, the CCA is associated with the NFc, the ACA is associated with the DCCF, the CCA includes the first CCA received in the first service request, the subject claim identifies the NFc, and the additional claim identifies the DCCF.

In some of the embodiments summarized above, the NFc is an NWDAF.

Other embodiments include DCCFs, NRFs, and NFps (or network equipment implementing the same) that are configured to perform the operations corresponding to any of the exemplary methods described herein. Other embodiments also include non-transitory, computer-readable media storing computer-executable instructions that, when executed by processing circuitry, configure such DCCFs, NRFs, and NFps to perform operations corresponding to any of the exemplary methods described herein.

These and other embodiments described herein may provide novel, flexible, and efficient techniques that facilitate more than one NF to be authenticated to a receiving NF (e.g., NRF or NFp), thereby allowing the receiving NF to determine which authenticated NF is linked to which claim(s) in an access token. Embodiments may provide transport of multiple CCAs while remaining backward-compatible with Rel-16 NRF and NFps. By providing improved data security in this manner, embodiments may prevent unauthorized exposure of sensitive data collected within a 5G network.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 is a signal flow diagram illustrating a technique for token-based authorization for access to 5G NF services.

FIG. 4 illustrates a high-level view of the 3GPP Rel-17 Data Management Framework.

FIG. 5 is a flow diagram of a conventional procedure for a data consumer NF to obtain data from a data source NF in a 5G network via a DCCF.

FIGS. 6-7 are flow diagrams of exemplary procedures for a data consumer NF to obtain data from a data source NF in a 5G network via an untrusted DCCF, according to various embodiments of the present disclosure.

FIG. 8 shows an exemplary method (e.g., procedure) performed by a DCCF of a communication network, according to various embodiments of the present disclosure.

FIG. 9 shows an exemplary method (e.g., procedure) performed by an NRF of a communication network, according to various embodiments of the present disclosure.

FIG. 10 shows an exemplary method (e.g., procedure) performed by a service producer NF of a communication network, according to various embodiments of the present disclosure.

FIG. 11 shows a communication system according to various embodiments of the present disclosure.

FIG. 12 shows a network node according to various embodiments of the present disclosure.

FIG. 13 is a block diagram of a virtualization environment in which functions implemented by some embodiments of the present disclosure may be virtualized.

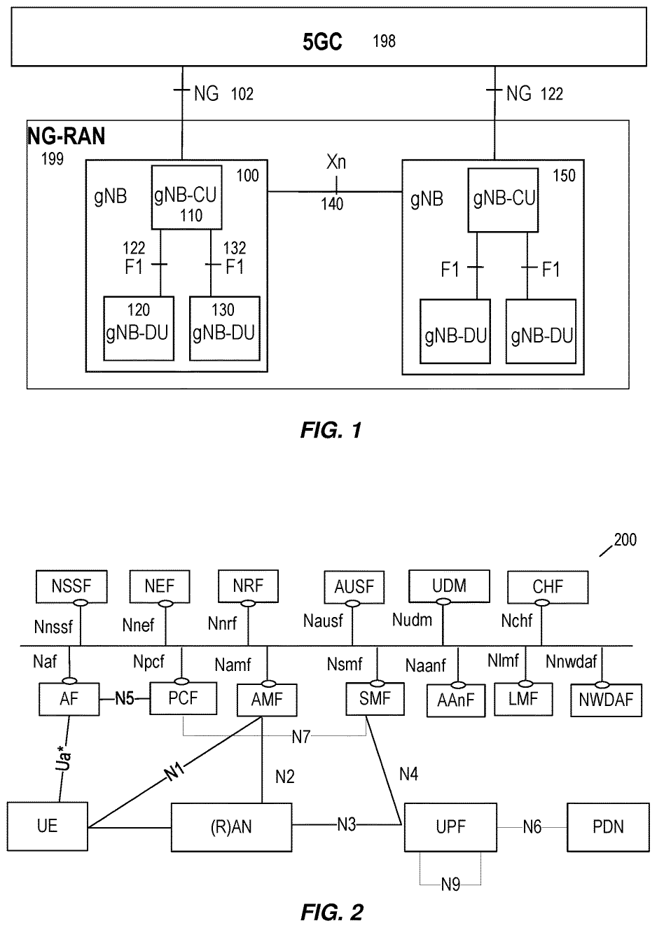

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary non-roaming reference architecture for a 5G network (200). These include the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF) supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF, with Nnef interface) acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF, 210, with Nnrf interface) provides service registration and discovery, enabling NFs to identify appropriate services available from other NFs.
Network Slice Selection Function (NSSF, with Nnssf interface): A “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF, with Nausf interface) performs user authentication and computes security key materials for various purposes, and is based in a user's home network (HPLMN).
Network Data Analytics Function (NWDAF, with Nnwdaf interface) provides network analytics information (e.g., statistical information of past events and/or predictive information) to other NFs on a network slice instance level.
Location Management Function (LMF, with Nlmf interface) supports various functions related to determination of UE locations, including location determination for a UE and obtaining any of the following: DL location measurements or a location estimate from the UE; UL location measurements from the NG RAN; and non-UE associated assistance data from the NG RAN.
Unified Data Management function (UDM, with Nudm interface) supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The services provided by the various NFs are composed of “service operations”, which are more granular divisions of the overall service functionality. The interactions between service consumers and producers can be of the type “request/response” or “subscribe/notify”. In the latter type, a service consumer NF (or equivalently, “consumer NF”) requests a service producer NF (or equivalently, “producer NF”) to establish a subscription for the service consumer NF to receive notifications from the service producer NF under conditions specified in this subscription.

Token-based authorization for the SBA is defined in 3GPP TS 33.501 (v16.5.0). This mechanism involves a consumer for a NF service (referred to as “NF Service Consumer” or more simply “Service Consumer”) obtaining an access token for the service from an authorization server before accessing the service. Access tokens are JSON Web Tokens as described in RFC 7519 (published by IETF) and are secured with digital signatures or Message Authentication Codes (MAC) based on JSON Web Signature (JWS) as described in IETF RFC 7515.

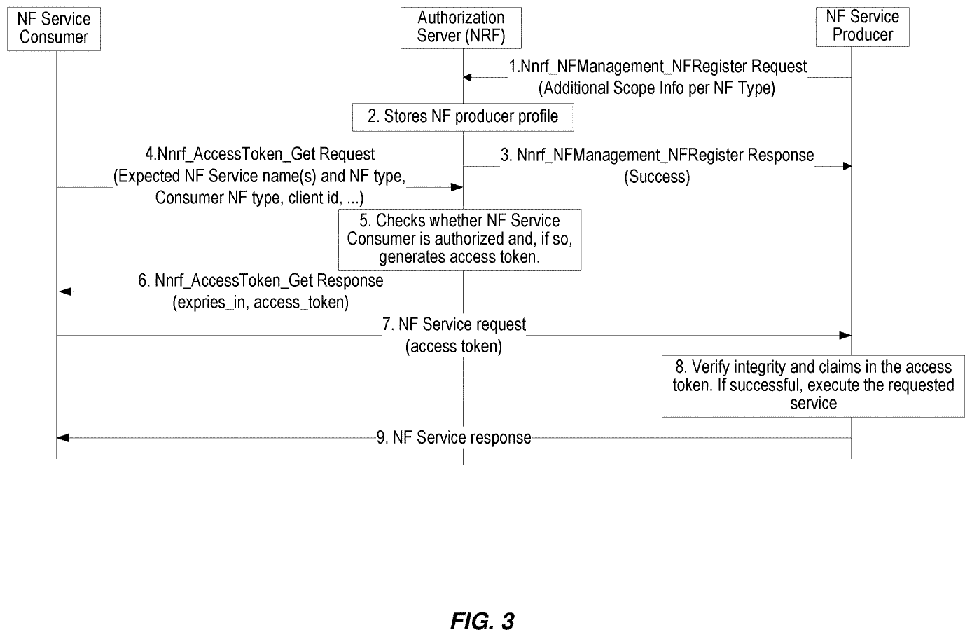

FIG. 3 shows a signal flow diagram illustrating token-based authorization for access to NF services. Operations 1-3 are part of the NF Service registration procedure in which the NF Service Producer provides information about the NF Service to the NRF, which stores this information in a NF producer profile. The service information may identify resources and actions (or service operations) that are allowed for NF Service Consumers.

In operation 4, a NF Service Consumer requests an access token from the NRF using the Nnrf_AccessToken_Get Request operation. The message includes the NF Instance ID(s) of the NF Service Consumer, the requested “scope” including the expected NF Service name(s), optionally “additional scope” information (e.g., requested resources and requested service operations on the resources), and NF types of the expected NF Service Producer instance and of the NF Service Consumer.

In operation 5, the NRF checks whether the NF Service Consumer is authorized to access the requested service(s). If the NF Service Consumer is authorized, the NRF generates an access token with appropriate claims included. The NRF digitally signs the generated access token based on a shared secret or private key as described in RFC 7515. If the NF Service Consumer is not authorized, the NRF does not issue the access token. In operation 6, the NRF sends the access token to the NF Service Consumer in an Nnrf_AccessToken_Get Response operation.

In operation 7, the NF Service Consumer requests service from the NF Service Producer and includes the obtained access token. In operation 8, the NF Service Producer verifies the access token integrity and claims within the access token. If successful, the NF Service Producer provides the requested service to the NF Service Consumer in operation 9.

Indirect communication in SBA was specified in 3GPP Rel-16, using a Service Communication Proxy (SCP) as a standardized proxy between Service Consumers and Service Producers. With respect to token-based authorization, Rel-16 added the capability for the SCP to request access tokens on behalf of Service Consumers.

As mentioned above, 3GPP Rel-17 enhances the SBA by adding a Data Management Framework that includes a Data Collection Coordination Function (DCCF) and a messaging framework, which are defined in detail in 3GPP TS 23.288 (v17.8.0). Data consumers ask DCCF for data collection in relation to a data producer. DCCF subscribes to the data producer (if not already subscribed), then coordinates the request and data delivery using the messaging framework. The data producer inputs the requested data to the messaging framework, which delivers the data to the data consumer.

The Data Management Framework is backward compatible with a Rel-16 NWDAF function, described above. For Rel-17, the baseline for services offered by the DCCF (e.g., to an NWDAF) are the Rel-16 NF Services used to obtain data. For example, the baseline for the DCCF service used by an NWDAF consumer to obtain UE mobility data is Namf_EventExposure.

A Rel-16 NWDAF can coexist with a Rel-17 NWDAF and the Data Management Framework. A Rel-16 NWDAF continues to request data directly from NFs without using the Data Management Framework and provides analytics to consumers that discover the Rel-16 NWDAF. A Rel-17 NWDAF can request data from the Data Management Framework, and if the data is not collected already, the Data Management Framework would request the data from a data source. In other words, a data source would independently send Data to the Rel-16 NWDAF that sent a request directly to the Data Source, and to the Data Management Framework that sent a request for the Rel-17 NWDAF.

In Rel-17, the NWDAF is decomposed by moving Data Collection, including the task of identifying the Data Source, to the Data Management Framework. The Rel-17 NWDAF requests data from the Data Management Framework but may not query other NFs (e.g., NRF, UDM, etc.) to determine which NF instance serves a UE, nor need it be concerned about life cycles of Data Source NFs, as was the case for Rel-16 NWDAF. This decomposition also allows other NFs to obtain data via the Data Management Framework and avoids duplicate data collection from the same Data Source. The Rel-17 NWDAF (without Data Collection) may be referred to as the “NWDAF Analytics Function.”

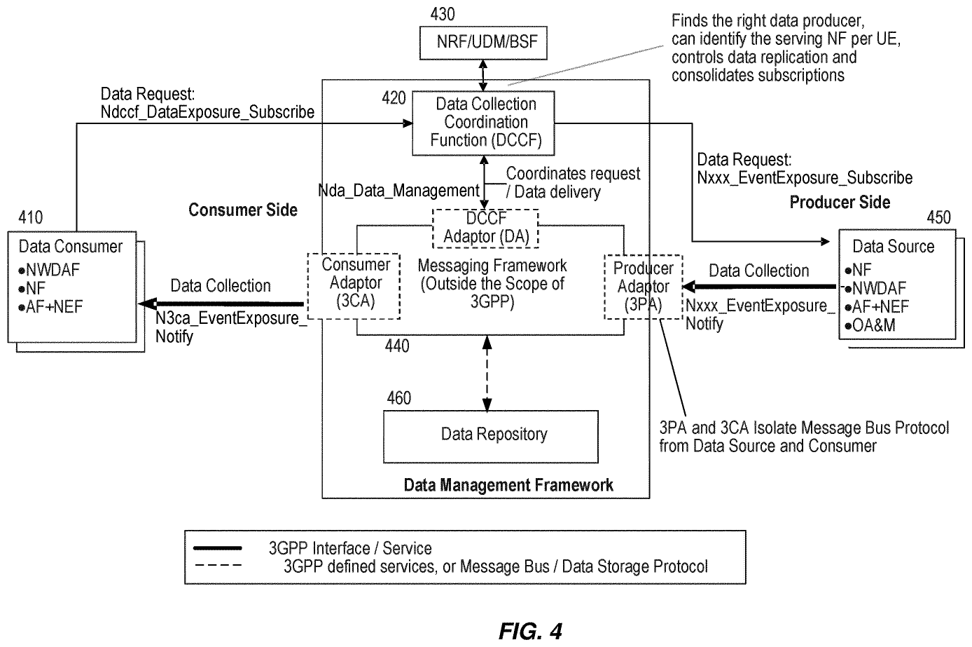

FIG. 4 illustrates a high-level view of the Rel-17 Data Management Framework. The main components are the DCCF (420) which communicates with other NFs; the Messaging Framework (440), which is outside the scope of 3GPP standardization; and a Data Repository (460). The DCCF optionally includes a DCCF Adaptor (DA) used to communicate with the Messaging Framework, which optionally includes a Consumer Adaptor (3CA) and/or a Producer Adaptor (3PA) used to communicate with a Data Consumer and a Data Source, respectively. The DA, 3CA, and 3PA may be standalone or combined with DCCF, Data Consumer (410), and Data Source (450), respectively. If standalone 3PAs and 3CAs are used, DCCF maintains (NF, 3PA) and (NF, 3CA) associations.

Exemplary Data Consumer NFs include, but are not limited to, the NWDAF. The Data Management Framework is compatible with both a 3GPP-defined Data Repository Function for ML/Analytics and Data Repositories that are not 3GPP-defined.

DCCF is a control-plane function that coordinates data collection and triggers data delivery to Data Consumers. DCCF may support multiple Data Sources, Data Consumers, and Message Frameworks. However, to prevent duplicate data collection, each Data Source is associated with only one DCCF. DCCF provides the 3GPP defined Ndccf_DataExposure Service to Data Consumers and uses the services of Data Sources to obtain data. Although FIG. 3 shows one DCCF for the 5GC, there can be multiple instances of the DCCF, e.g., for different network slices, different geographic regions where Data Sources reside, or different Data Source types.

For DCCF discovery, the DCCF registers with an NRF (430) and is discovered by Consumers or an SCP using the registration and discovery procedures defined for the NF Service Framework in 3GPP TS 23.502 (v16.7.0). The DCCF profile in the NRF may specify:
Slices (S-NSSAIs) that a DCCF supports;
Source Types that a DCCF coordinates; and
Serving area (e.g., list of TAIs) containing Data Sources that a DCCF coordinates.
   Source Type may be an NF Type (e.g., SMF, AMF, etc.) or a domain (e.g., OA&M). Hence a Consumer or SCP may request or select a DCCF according to the type of information it is requesting, the network slices it supports, and/or its serving area.

In general, a DCCF is aware of the Data Sources that it coordinates. NRF and UDM can provide the DCCF with the identity of 5GC Data Sources (e.g., an AMF serving a UE). The DCCF also hides Data Source life cycle events and changes of entity serving a UE from the Data Consumer. For example, if a UE's serving NF Data Source changes because of a life-cycle event, the NRF may notify a DCCF that has previously subscribed to NRF event notifications. The DCCF may also use the UDM to learn the new (UE, NF) association, thus making the change of the NF serving a UE transparent to the Data Consumer.

The NWDAF acting as “Data Source” supplies Analytics output as “Data”, using the services defined in 3GPP TS 23.288 (v17.8.0) section 7 (subscribe/notify), similar to other NFs. DCCF is not intended to support aggregation of analytics data across multiple NWDAFs. However, DCCF keeps track of Consumer Requests to the NWDAF (acting as a “Data Source”) and thus knows which analytics are produced by an NWDAF. Therefore, the Data Management Framework may be used by any NF (e.g., an NWDAF) that consumes (or aggregates) analytics data from one or more NWDAFs acting as a “Data Source” or from the Data Repository.

A DCCF receives data requests from Data Consumers via the Ndccf_DataExposure service. If a Data Source is not specified in the Data Request, the DCCF determines the Data Source that can provide the data requested by the Data Consumer (e.g., an event requested by the Data Consumer for NF event exposure). For example, if the request is for UE-specific data, the DCCF may query the other NFs (e.g., NRF, UDM, etc.) to determine which NF instance is serving the UE. If the Data Source is specified in the Data Request (e.g., the Data Consumer is configured with Data Sources), the DCCF checks whether the data is already collected from the Data Source. If not, the DCCF will request the data from the specified Data Source.

Additionally, the DCCF may determine if the requested data is currently being produced by any Data Source and being provided to the Messaging Framework. If the requested data is not being produced and/or provided, the DCCF sends a new subscription/request towards the Data Source to trigger a new data collection, and the DCCF then subscribes with the messaging framework for the Data Consumer to receive future event notifications associated with the desired Data Source. Similarly, when the last Data Consumer of specific data no longer wants that data, the DCCF cancels data collection from the Data Source and from the Messaging Framework. This ensures that the Data Source is only producing the same data once for multiple Data Consumers and is not producing data that no Data Consumer needs.

If the requested data is partially covered by existing subscriptions with a Data Source, the DCCF sends to the Data Source a request to modify the existing subscription (if the Data Source can fulfil the newly requested data) or creates new subscription(s) to another Data Source for the newly requested data that cannot be provided by the original Data Source. If the newly requested data is already being collected from the Data Source, the DCCF determines that no subscriptions to the Data Source need to be created or modified.

The DCCF determines if data is already being collected based on maintaining a record of previous requests it made for data (e.g., via an Nnf_EventExposure service offered by the Data Source). If parameters in a previous request for data match those that are needed in a subsequent request, the DCCF may determine that the requested data is already being collected. The DCCF may then subscribe with the messaging framework for the new Consumer to receive future notifications.

Each Data Consumer may specify in its request to the DCCF multiple notification endpoints, which may include the requesting Data Consumer, an ADRF, or other NFs. Each event notification received from a Data Source NF is sent to the DCCF, which propagates it to all Data Consumers or Notification Endpoints specified by Data Consumers or determined by the DCCF. The DCCF may also select an ADRF or other notification endpoint based on configuration. The DCCF supports formatting and processing for each Consumer/notification endpoint so notifications comply with the data requests received from the respective consumer NFs.

When notifications are received by the DCCF, they are processed according to the Formatting and Processing Instructions for each Consumer and notification endpoint. The DCCF subsequently sends notifications to Consumers and notification endpoints via a Ndccf_DataManagement service.

The Messaging Framework is not expected to be standardized by 3GPP. It contains Messaging Infrastructure that propagates event information and data (e.g.: streaming and notifications) from Data Sources to Data Consumers. The Messaging Framework may support the “pub-sub” pattern, in which data is published by producer adaptors (or Data Source if the Data Source natively supports the message bus protocol) and can be subscribed to by consumer adaptor (or Data Consumer if the Data Consumer natively supports the message bus protocol).

The Messaging Framework may support multiple event delivery mechanisms such as best effort or guaranteed delivery. The Messaging Framework may contain one or more Adaptors that translate between 3GPP defined protocols (e.g., Rel-16 Nnwdaf_AnalyticsSubscription_Notify) and a Data Forwarding Protocol not specified by 3GPP. The Messaging Framework adaptors maintain subscription information, including formatting conditions and processing instructions received by the DA.

The adaptor on the Data Producer side (3PA) allows any source data (e.g., from Rel-16 OA&M or NF EventExposure) to be distributed via the framework without impact on the Data Source. The DCCF keeps track on the Adaptor instances. An Adaptor may be associated with specific NF types, manage one or more data Sources, and may be provisioned on the DCCF together with the Data Sources it supports. If the Messaging Framework directly supports 3GPP interfaces, adaptors may not be required.

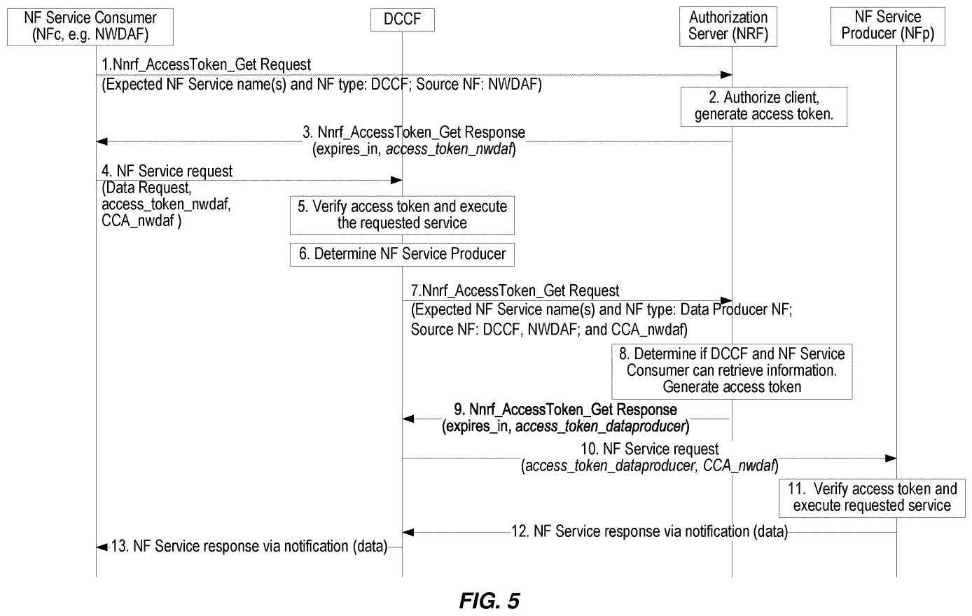

FIG. 5 shows a signal flow diagram of an exemplary procedure for an NF Service Consumer (e.g., NWDAF) to receive data from an NF Service Producer via DCCF. Although the operations shown in FIG. 5 are given numerical labels, this is intended to facilitate explanation rather than to require or imply any specific operational order, unless expressly stated otherwise.

In operations 1-3, the NF Service Consumer (NFc) sends a request to NRF to receive an access token to request services of DCCF, to be used for a data collection request. After verifying the NFc's request, the NRF generates the requested access token (“access_token_nwdaf”) and sends it to the NFc.

In operation 4, the NFc initiates a NF service request to the DCCF and includes access_token_nwdaf in the service request. As described in the 3GPP TS 33.501 (v17.9.0) section 13.3.8, the NFc also generates a Client Credentials Assertion (CCA) token (CCA_NWDAF) and includes it in the service request. This token enables the NFc to authenticate itself towards NF Service Producers or other receiving endpoints (e.g., NRF). The procedure of NFc (e.g., NWDAF) requesting services provided by an NFp via DCCF is further described in 3GPP TS 23.288 (v17.8.0) section 6.2.6.3.

In operation 5, the DCCF verifies whether access_token_nwdaf is valid and, if verified, initiates execution of the requested service. In operation 6, the DCCF determines the NFp(s) from where the requested data is to be collected, as further described in 3GPP TS 23.288 (v17.8.0) section 6.2.6.3.2. If NFc sends NFp details such as NF Service Producer Type and Instance ID along with the service request in operation 4, then DCCF does not determine the NF Service Producer, but requests an access token from the NRF using the NFp details received in operation 4.

In operation 7, the DCCF sends a Nnrf_AccessToken_Get request to NRF including the information identifying the target NF (NFp), the source NF (NFc, e.g., NWDAF), the NF Instance ID of the requesting DCCF, and the CCA_NWDAF provided by the NFc. Note that the NF Instance ID of DCCF is included in a different IE than the source NF, so a Rel-16 NRF will ignore the new IE.

In operation 8, the NRF checks whether the DCCF and the NFc (e.g., NWDAF) are allowed to access the service provided by the identified NFp(s), and that the DCCF as the proxy is allowed to request the service from the identified NFp(s) on behalf the NFc. The NRF authenticates both DCCF and NWDAF based on one of the SBA methods described in 3GPP TS 33.501 (v17.9.0) section 13.3.1.2. Note that the DCCF may include an additional CCA for authentication.

In the context of operation 8, a Rel-16 NRF takes CCA to authenticate NFc if available (i.e., authentication is not based on TLS). Also, if the NRF is Rel-16 or earlier, after the NRF receives Nnrf_AccessToken_Get request, it validates whether the NFc (e.g., NWDAF) is authorized to receive the requested service from the NFp but does not validate whether the DCCF is authorized to receive the requested service.

In operation 9, after successful verification the NRF generates and provides an access token to the DCCF as described in 3GPP TS 33.501 (v17.9.0) section 13.4.1.1.2, with NFc Instance (subject) and an additional access token claim containing the identity of DCCF. This information serves to authorize both the NFc (e.g., NWDAF) and the DCCF to consume the services of NFp. If the NRF is from Rel-16 or earlier, it generates an OAuth2.0 access token with “subject” claim mapped to the NFc (e.g., NWDAF) and but no additional claims for the DCCF.

In operation 10, the DCCF requests service from the NFp. The request includes CCA_NWDAF received from NFc, which enables the NFp(s) to authenticate the NFc. In operation 11, the NFp(s) authenticates the NFc and verifies the received access token as specified as described in 3GPP TS 33.501 (v17.9.0) section 13.4.1.1.2. This includes verifying that the DCCF identity is included as an access token additional claim. If the DCCF identity is not included in the access token additional claims (e.g., NRF is Release 16 or prior), the NFp shall authorize the DCCF locally. A Rel-16 NFp uses CCA to authenticate an NFc if available, such as when authentication is not based on TLS.

After authentication and authorization is successful, the NFp(s) assures that the DCCF as the proxy is allowed to receive the response message on behalf the NFc and execute the service after successful verification. Note that DCCF may include an additional CCA for authentication.

In operations 12-13, the NFp(s)l provide the requested data to the DCCF, which forwards the received data to the NFc.

In case a new NFc later request the same data, which is already being collected by DCCF, operations 1-10 apply When the request is received by the NFp (i.e. the data producer), it authenticates the new NFc, verifies the access token provided along with the service request, and sends to DCCF the access token verification response. Based upon the response received, DCCF either updates the subscription to include the new NFc and sends the data to both NFc (in case of access token verification) or rejects the request by the new NFc (in the case of access token verification failure).

If the NFp is Rel-16 or earlier, it authorizes the NFc (e.g., NWDAF) by validating the received OAuth2.0 access token which has “subject” claim mapping to the NFc. Authorization of the DCCF by Rel-16 or earlier NFp is deployment specific based on any of the available 5GC authorization methods.

The above description of operations 8 and 11 mentions that two CCAs may need to be included in certain messages. However, it is unclear how these CCAs are used and linked to the access token(s). The access token sent to NFp in the above procedure includes the fields listed in the table below, with subject claim (“sub” field) mapped to DCCF and Source NF claim (“sourceNFInstanceId” field) mapped to NFc (e.g., NWDAF). Note that “card” column header is an abbreviation for “cardinality”, i.e., how many of each attribute or field the access token includes.

| Attribute name | Data type | P | Card. | Description |
|---|---|---|---|---|
| iss | NfInstanceId | M | 1 | NF instance id of the NRF, corresponding to |
| | | | | the standard “Issuer” claim described in |
| | | | | IETF RFC 7519, clause 4.1.1 |
| sub | NfInstanceId | M | 1 | NF instance ID of NF service consumer, |
| | | | | corresponding to the standard “Subject” claim |
| | | | | described in IETF RFC 7519, clause 4.1.2. |
| . . . | | | | |
| sourceNfInstanceId | NfInstanceId | C | 0 . . . 1 | Included if NRF supports providing NF |
| | | | | Instance ID of the source NF in the access |
| | | | | token claims (if it is an access token request |
| | | | | from the DCCF as NF Service Consumer |
| | | | | request data from NF Service Producers on |
| | | | | behalf of the source NF), to be interpreted for |
| | | | | subject (sub IE), as specified in Annex X of |
| | | | | 3GPP TS 33.501 (v17.9.0). |

Similarly, the access token requests sent to NRF in the above procedure include the fields listed in the table below.

| Attribute name | Data type | P | Card. | Description |
|---|---|---|---|---|
| grant_type | string | M | 1 | Grant type of “client_credentials”. |
| | | | | Enum: “client credentials” |
| nfInstanceId | NfInstanceId | M | 1 | NF instance id of the NF service consumer. |
| nfType | NFType | C | 0 . . . 1 | Included when access token request is for an |
| | | | | NF type and not for a specific NF/NF service |
| | | | | instance. When present, this IE shall contain |
| | | | | the NF type of the NF service consumer. |
| . . . | | | | |
| sourceNfInstanceId | NfInstanceId | C | 0 . . . 1 | Included if available and if it is an access |
| | | | | token request from the DCCF as NF Service |
| | | | | Consumer request data from NF Service |
| | | | | Producers on behalf of the source NF. |
| | | | | When present this IE shall contain the NF |
| | | | | Instance ID of the source NF which intends |
| | | | | to collect data from NF Service Producer. |

It has been recognized that 3GPP TS 29.510 (v17.9.0) and 3GPP TS 33.501 (v17.9.0) use different fields in the access token request and the access token to carry the NF Instance ID of the NFc and the DCCF.

Although not shown in FIG. 5, operations 7-9 and/or operations 10-12 may be performed according to the indirect communication model. In other words, DCCF may communicate with NRF (operations 7, 9) and with NFp (operations 10, 12) via an SCP. In such case, the receiving entity may require that the access token request (operation 7) and the service request (operation 10) also include a client credential of the requesting DCCF. In other words, both the CCA of the NFc and the CCA of the DCCF may need to be included in these two requests. However, this is not possible given the request structure specified in the table above.

Furthermore, even if multiple CCAs (i.e., NFc, DCCF) were present in the service request, the NF service producer (NFp) currently has no way to determine which NF is authenticated and linked with specific claim(s) in the access token (e.g., subject claim, source NF claim). Similar problems exist regarding backward compatibility with Rel-16 NRFs and NFps.

Embodiments of the present disclosure address these and other problems, issues, and/or difficulties by providing novel, flexible, and efficient techniques that address scenarios in which more than one NF needs to be authenticated to a receiving NF (e.g., NRF or NFp), thereby allowing the receiving NF to determine which authenticated NF is linked to which claim(s) in an access token. These techniques may provide transport of multiple CCAs while remaining backward-compatible with Rel-16 NRF and NFps. By providing improved security in this manner, embodiments can prevent unauthorized exposure of sensitive data collected within a 5G network.

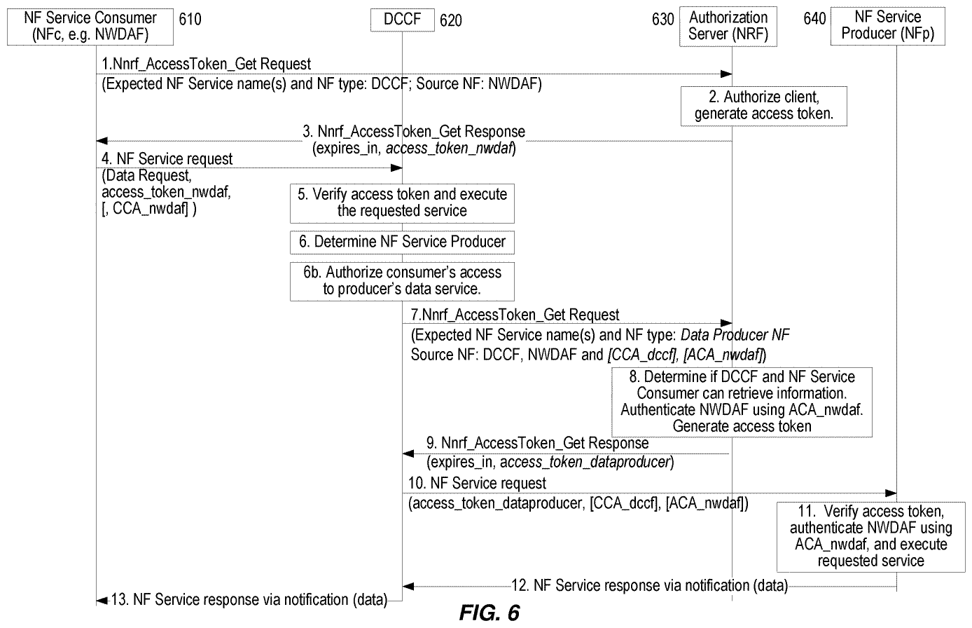

FIG. 6 shows a signal flow diagram of an exemplary procedure for an NF Service Consumer (e.g., NWDAF) to receive data from an NF Service Producer via DCCF, according to various embodiments of the present disclosure. In particular, FIG. 6 shows an NFc (610), a DCCF (620), an authorization server (630, e.g., NRF), and an NFp (640). The entities shown in FIG. 6 are the same as those shown in FIG. 5, discussed above. Although the operations shown in FIG. 6 are given numerical labels, this is intended to facilitate explanation rather than to require or imply a numerical order of the operations, unless specifically noted otherwise in the description below.

Operations 1-6 are substantially identical to operations 1-5 in FIG. 5, described above. In operation 4, the NFc optionally includes its CCA_nwdaf.

In operation 6b, for backward-compatibility with a Rel-16 NRF that does not understand Rel-17 (and beyond) information in an access token request (as explained below), the DCCF can perform the authorization of the NFc's access to the NFp's data and/or service.

In operation 7, the DCCF sends a Nnrf_AccessToken_Get request to NRF including the information identifying the target NF (NFp), the source NF (NFc, e.g., NWDAF), and the NF Instance ID of the requesting DCCF. The DCCF optionally includes its own CCA (CCA_dccf), as described in 3GPP TS 33.501 (v17.9.0) sections 13.3.2.2 and 13.3.8. Additionally, the DCCF includes the CCA_nwdaf if received in operation 4, but in a new header called ACA_nwdaf, where “ACA” stands for “additional credentials assertion”.

In operation 8, the NRF checks whether the DCCF and the NFc (e.g., NWDAF) are allowed to access the service provided by the identified NFp(s), and that the DCCF as the proxy is allowed to request the service from the identified NFp(s) on behalf the NFc. The NRF authenticates DCCF based on one of the SBA methods described in 3GPP TS 33.501 (v17.9.0) section 13.3.1.2. For example, NRF may authenticate DCCF for indirect communication based on received CCA_dccf. Optionally, NRF authenticates the NFc behind the proxy DCCF using the ACA_nwdaf received in operation 7, and only issues the access token if the authentication is successful. Rel-16 NRFs may skip authentication of NFc in this operation and only authenticate DCCF.

In operation 9, after successful verification the NRF generates and provides an access token to DCCF as described in 3GPP TS 33.501 (v17.9.0) section 13.4.1.1.2, with subject claim containing the identity of DCCF and an additional access token claim containing the identity of NFc, corresponding to the authenticated ACA_nwdaf. This enables authorization of both NFc (e. g .. NWDAF) and DCCF to consume services of the NFp. If the NRF is from Rel-16 or earlier, it generates an OAuth2.0 access token with “subject” claim mapped to the NFc (e.g., NWDAF) and but no additional claims for the DCCF.

In operation 10, the DCCF requests service from the NFp. The request includes CCA NWDAF received from NFc, which enables the NFp(s) to authenticate the NFc. The DCCF optionally includes its CCA_dccf, as described in 3GPP TS 33.501 (v17.9.0) sections 13.3.2.2 and 13.3.8. Additionally, the DCCF includes the CCA_nwdaf received in operation 4, but in in a new header called ACA_nwdaf (discussed above).

In operation 11, the NFp(s) authenticates the NFc and verifies the received access token as specified as described in 3GPP TS 33.501 (v17.9.0) section 13.4.1.1.2. This includes verifying that the DCCF identity is included as an access token subject claim and the NFc (e.g., NWDAF) identity is included as additional NF claim.

For example, the NFp authenticates DCCF based on CCA_dccf for indirect communication. Optionally, the NFp authenticates the NFc behind the DCCF proxy using the ACA_nwdaf received in operation 10, and only provides the service response if the authentication is successful. Rel-16 NFps may skip authentication of NFc in this operation and only authenticate DCCF.

In some embodiments, the ACA_nwdaf header mentioned above may support credentials assertion for one or more NFs. Likewise, in some embodiments, the access token may support one or more additional NF claims for NFcs.

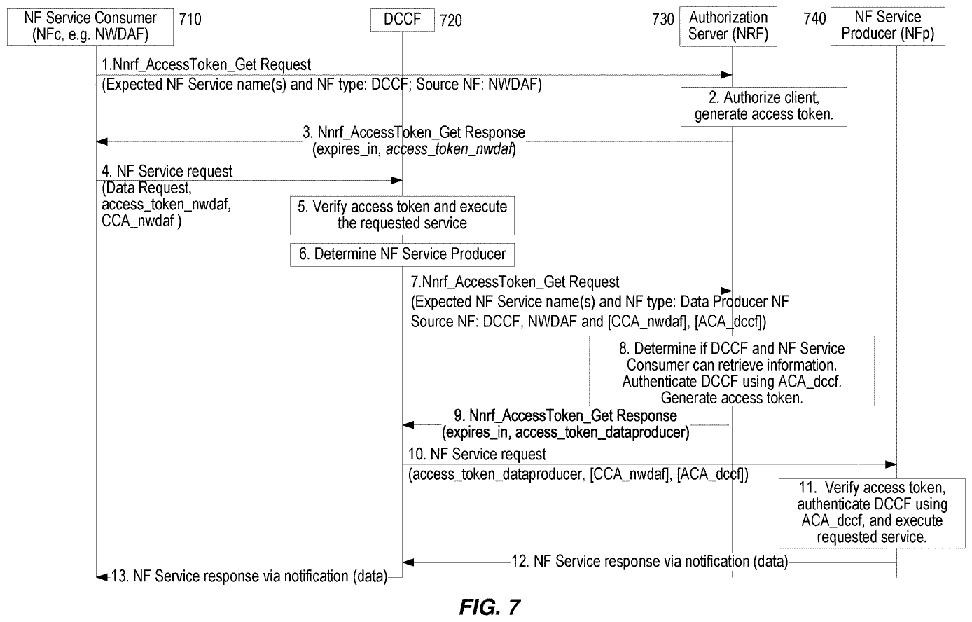

FIG. 7 shows a signal flow diagram of another exemplary procedure for an NF Service Consumer (e.g., NWDAF) to receive data from an NF Service Producer via DCCF, according to various embodiments of the present disclosure. In particular, FIG. 7 shows an NFc (710), a DCCF (720), an authorization server (730, e.g., NRF), and an NFp (740). The entities shown in FIG. 7 are the same as those shown in FIG. 5, discussed above. Although the operations shown in FIG. 7 are given numerical labels, this is intended to facilitate explanation rather than to require or imply a numerical order of the operations, unless specifically noted otherwise in the description below.

Operations 1-6 are substantially identical to operations 1-5 in FIG. 5, described above. In operation 4, the NFc optionally includes its CCA_nwdaf.

In operation 7, the DCCF sends a Nnrf_AccessToken_Get request to NRF including the information identifying the target NF (NFp), the source NF (NFc, e.g., NWDAF), and the NF Instance ID of the requesting DCCF. The DCCF includes the CCA_nwdaf received in operation, and optionally includes its own CCA (CCA_dccf) but in a new header called ACA_nwdaf.

In operation 8, the NRF checks whether the DCCF and the NFc (e.g., NWDAF) are allowed to access the service provided by the identified NFp(s), and that the DCCF as the proxy is allowed to request the service from the identified NFp(s) on behalf the NFc. The NRF authenticates the NFc behind the proxy DCCF using the CCA_nwdaf received in operation 7. The NRF authenticates DCCF based on one of the SBA methods described in 3GPP TS 33.501 (v17.9.0) section 13.3.6, e.g., similar to SCP. Optionally, a Rel-17 NRF may authenticate DCCF for indirect communication based on ACA_dccf if received in operation 7. NRF only issues the access token if the authentication is successful.

In operation 9, after successful verification the NRF generates and provides an access token to DCCF as described in 3GPP TS 33.501 (v17.9.0) section 13.4.1.1.2, with subject claim containing the identity of the NFc and an additional access token claim containing the identity of DCCF, corresponding to the authenticated ACA_dccf. This enables authorization of both NFc (e. g .. NWDAF) and DCCF to consume services of the NFp. If the NRF is from Rel-16 or earlier, it generates an OAuth2.0 access token with “subject” claim mapped to the NFc (e.g., NWDAF) and but no additional claims for the DCCF.

In operation 10, the DCCF requests service from the NFp. The request includes CCA_nwdaf if received from NFc in operation 4, which enables the NFp(s) to authenticate the NFc. The DCCF optionally includes its own CCA_dccf but in in a new header called ACA_dccf.

In operation 11, the NFp(s) verifies the received access token as described in 3GPP TS 33.501 (v17.9.0) section 13.4.1.1.2. This includes verifying that the NFc (e.g., NWDAF) identity is included as an access token subject claim and the DCCF identity is included as additional NF claim. The NFp authenticates DCCF based on one of the SBA methods described in clause 13.3.6, e.g., similar to SCP. Optionally, an Rel-17 NFp authenticates the DCCF using the ACA_dccf received in operation 10, and only provides the service response if the authentication is successful.

In some embodiments, the ACA_dccf header mentioned above may support credentials assertion for one or more NFs. Likewise, in some embodiments, the access token may support one or more additional NF claims for NFcs.

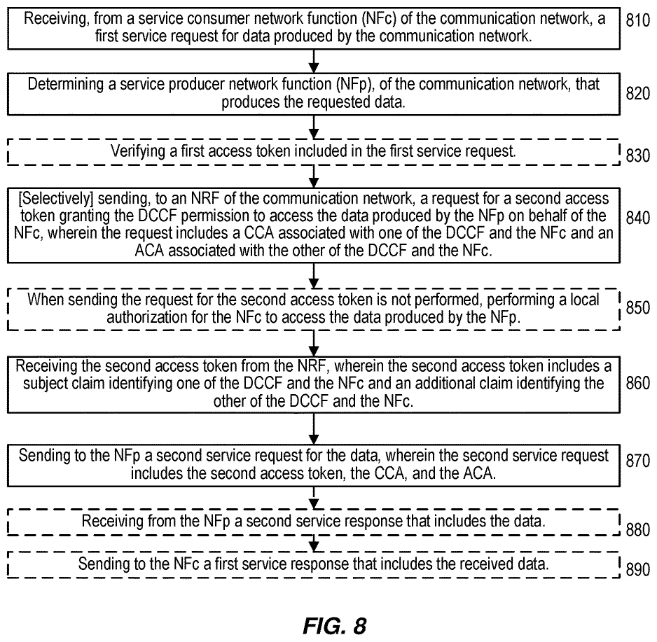

The embodiments described above can be further illustrated with reference to FIGS. 8-10, which depict exemplary methods (e.g., procedures) performed by a DCCF, an NRF, and a service producer NF, respectively. Put differently, various features of the operations described below correspond to various embodiments described above. The exemplary methods shown in FIGS. 8-10 can be used cooperatively (e.g., with each other and with other procedures described herein) to provide benefits, advantages, and/or solutions to problems described herein. Although the exemplary methods are illustrated in FIGS. 8-10 by specific blocks in particular orders, the operations corresponding to the blocks can be performed in different orders than shown and can be combined and/or divided into blocks or operations having different functionality than shown. Optional features, operations, and/or blocks are indicated by dashed lines.

FIG. 8 illustrates an exemplary method (e.g., procedure) performed by a DCCF of a communication network (e.g., 5GC), according to various embodiments of the present disclosure. The exemplary method shown in FIG. 8 can be performed by a DCCF (or network equipment configured to implement a DCCF) such as described elsewhere herein.

The exemplary method can include the operations of block 810, where the DCCF can receive, from a service consumer network function (NFc) of the communication network, a first service request for data produced by the communication network. The exemplary method can also include the operations of block 820, where the DCCF can determine a service producer network function (NFp) that produces the requested data. The exemplary method can also include the operations of block 840, where the DCCF can send, to an NRF of the communication network, a request for a second access token granting the DCCF permission to access the data produced by the NFp on behalf of the NFc. The request includes a client credentials assertion (CCA) associated with one of the DCCF and the NFc, and an additional credentials assertion (ACA) associated with the other of the DCCF and the NFc.

The exemplary method can also include the operations of block 860, where the DCCF can receive the second access token from the NRF. The second access token includes a subject claim identifying one of the DCCF and the NFc and an additional claim identifying the other of the DCCF and the NFc. The exemplary method can also include the operations of block 870, where the DCCF can send to the NFp a second service request for the data. The second service request includes the second access token, the CCA, and the ACA.

In some embodiments, the exemplary method can also include the operations of blocks 880-890, where the DCCF can receive from the NFp a second service response that includes the data and send to the NFc a first service response that includes the received data.

In some embodiments, the first service request also includes a first CCA associated with the NFc. In some of these embodiments, the CCA is associated with the DCCF, the ACA is associated with the NFc, the ACA includes the first CCA received in the first service request, and the subject claim identifies the DCCF and the additional claim identifies the NFc. FIG. 6 shows an example of these embodiments.

In other of these embodiments, the CCA is associated with the NFc, the ACA is associated with the DCCF, the CCA includes the first CCA received in the first service request, the subject claim identifies the NFc, and the additional claim identifies the DCCF. FIG. 7 shows an example of these embodiments.

In some embodiments, the first service request includes a first access token granting the NFc permission to access the DCCF. In such embodiments, sending the request for the second access token in block 840 is based on the operations of block 830, where the DCCF verifies the first access token.

In some embodiments, sending the request for the second access token in block 840 is performed selectively according to one or more of the following: NRF support of authorization based on CCA and ACA, and local configuration of the DCCF. In other words, the DCCF may refrain from sending the request for the second access token to the NRF (and thus receiving the second access token from NRF) based one or more of these criteria. In such embodiments, when sending the request for the second access token is not performed in block 840, the exemplary method includes the operations of block 850, where the DCCF performs a local authorization for the NFc to access the data produced by the NFp.

In some embodiments, the NFc is an NWDAF. In some embodiments, the ACA also includes a CCA associated with at least one additional NF and the second access token also includes at least one further additional claim identifying the respective at least one additional NF.

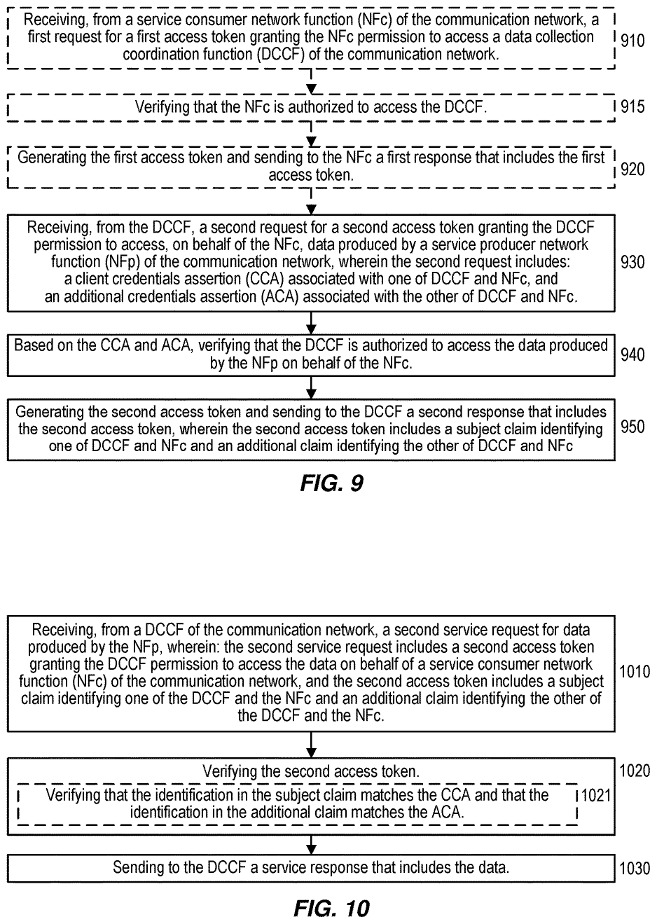

In addition, FIG. 9 illustrates an exemplary method (e.g., procedure) performed by an NRF of a communication network (e.g., 5GC), according to various embodiments of the present disclosure. The exemplary method shown in FIG. 9 can be performed by an NRF (or network equipment configured to implement an NRF) such as described elsewhere herein.

The exemplary method includes the operations of block 930, where the NRF can receive, from a DCCF of the communication network, a second request for a second access token granting the DCCF permission to access, on behalf of a service consumer network function (NFc) of the communication network, data produced by a service producer network function (NFp) of the communication network. The second request includes a client credentials assertion (CCA) associated with one of the DCCF and the NFc and an additional credentials assertion (ACA) associated with the other of the DCCF and the NFc.

The exemplary method also includes the operations of block 940, where based on the CCA and ACA, the NRF can verify that the DCCF is authorized to access the data produced by the NFp on behalf of the NFc. The exemplary method also includes the operations of block 950, where based on verifying that the DCCF is authorized to access the data (e.g., in block 940), the NRF can generate the second access token and send to the DCCF a second response that includes the second access token. The second access token includes a subject claim identifying one of the DCCF and the NFc and an additional claim identifying the other of the DCCF and the NFc.

In some embodiments, the exemplary method can also include the operations of blocks 910-920, where the NRF can receive from the NFc a first request for a first access token granting the NFc permission to access the DCCF and based on verifying that the NFc is authorized to access the DCCF, generate the first access token and send to the NFc a first response that includes the first access token.

In some embodiments, the CCA is associated with the DCCF, the ACA is associated with the NFc, the ACA includes a first CCA associated with the NFc, the subject claim identifies the DCCF, and the additional claim identifies the NFc. FIG. 6 shows an example of these embodiments.

In other embodiments, the CCA is associated with the NFc, the ACA is associated with the DCCF, the subject claim identifies the NFc, and the additional claim identifies the DCCF. FIG. 7 shows an example of these embodiments.

In some embodiments, the NFc is an NWDAF. In some embodiments, the ACA also includes a CCA associated with at least one additional NF and the second access token also includes at least one further additional claim identifying the respective at least one additional NF.

In addition, FIG. 10 illustrates an exemplary method (e.g., procedure) performed by a service producer NF (NFp) of a communication network (e.g., 5GC), according to various embodiments of the present disclosure. The exemplary method shown in FIG. 10 can be performed by any appropriate NFp (or network equipment configured to implement an NFp) such as described elsewhere herein.

The exemplary method includes the operations of block 1010, where the NFp can receive, from a DCCF of the communication network, a second service request for data produced by the NFp. The second service request includes a second access token granting the DCCF permission to access the data on behalf of a service consumer network function (NFc) of the communication network. The second access token includes a subject claim identifying one of the DCCF and the NFc and an additional claim identifying the other of the DCCF and the NFc.

The exemplary method also includes the operations of blocks 1020-1030, where the NFp can verify the second access token and based on verifying the second access token, send to the DCCF a service response that includes the data.

In some embodiments, the second service request also includes a CCA associated with the one of the DCCF and the NFc, and an ACA associated with the other of the DCCF and the NFc. In some of these embodiments, verifying the second access token in block 1020 can include the operations of sub-block 1021, where the NFp can verify that the identification in the subject claim matches the CCA and that the identification in the additional claim matches the ACA.

In some of these embodiments, the CCA is associated with the DCCF, the ACA is associated with the NFc, the ACA includes the first CCA received in the first service request, the subject claim identifies the DCCF, and the additional claim identifies the NFc. FIG. 6 shows an example of these embodiments.

In other embodiments, the CCA is associated with the NFc, the ACA is associated with the DCCF, the CCA includes the first CCA received in the first service request, the subject claim identifies the NFc, and the additional claim identifies the DCCF. FIG. 7 shows an example of these embodiments.

In some embodiments, the NFc is an NWDAF. In some embodiments, the ACA also includes a CCA associated with at least one additional NF and the second access token also includes at least one further additional claim identifying the respective at least one additional NF.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

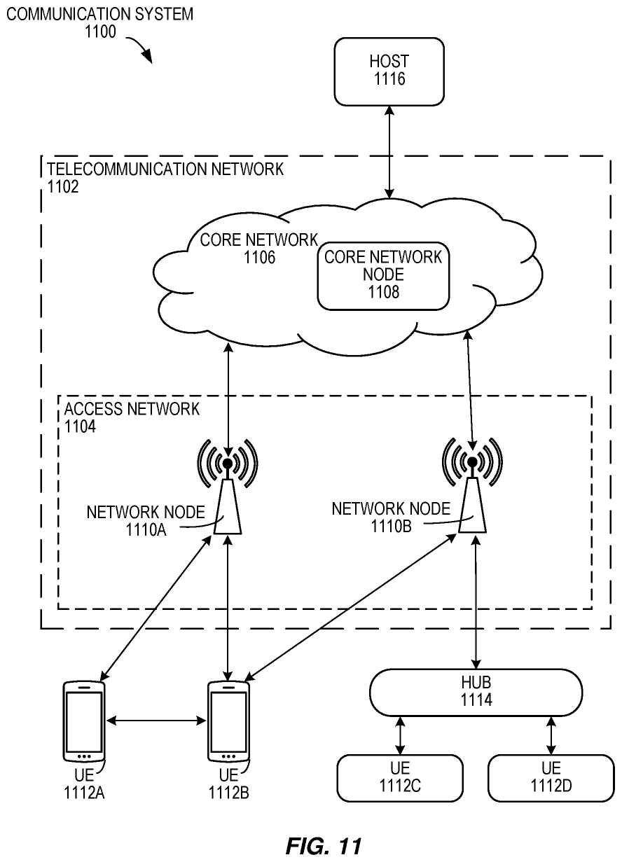

FIG. 11 shows an example of a communication system 1100 in accordance with some embodiments. In this example, communication system 1100 includes a telecommunication network 1102 that includes access network 1104 (e.g., RAN) and core network 1106, which includes one or more core network nodes 1108. Access network 1104 includes one or more access network nodes, such as network nodes 1110a-b (one or more of which may be generally referred to as network nodes 1110), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1102 includes one or more Open-RAN (ORAN) network nodes. An ORAN network node is a node in telecommunication network 1102 that supports an ORAN specification (e.g., a specification published by the O-RAN Alliance, or any similar organization) and may operate alone or together with other nodes to implement one or more functionalities of any node in telecommunication network 1102, including one or more network nodes 1110 and/or core network nodes 1108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1110 facilitate direct or indirect connection of UEs, such as by connecting UEs 1112a-d (one or more of which may be generally referred to as UEs 1112) to core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1100 may include any number of wired or wireless networks, network nodes, UEs, and/or any other components or systems that may facilitate or participate in the communication of data and/or signals whether via wired or wireless connections. Communication system 1100 may include and/or interface with any type of communication, telecommunication, data, cellular, radio network, and/or other similar type of system.

UEs 1112 may be any of a wide variety of communication devices, including wireless devices arranged, configured, and/or operable to communicate wirelessly with network nodes 1110 and other communication devices. Similarly, network nodes 1110 are arranged, capable, configured, and/or operable to communicate directly or indirectly with UEs 1112 and/or with other network nodes or equipment in telecommunication network 1102 to enable and/or provide network access, such as wireless network access, and/or to perform other functions, such as administration in telecommunication network 1102.

In the depicted example, core network 1106 connects network nodes 1110 to one or more hosts, such as host 1116. These connections may be direct or indirect via one or more intermediary networks or devices. In other examples, network nodes may be directly coupled to hosts. Core network 1106 includes one or more core network nodes (e.g., 1108) that are structured with hardware and software components. Features of these components may be substantially similar to those described with respect to the UEs, network nodes, and/or hosts, such that the descriptions thereof are generally applicable to the corresponding components of core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1116 may be under the ownership or control of a service provider other than an operator or provider of access network 1104 and/or telecommunication network 1102, and may be operated by the service provider or on behalf of the service provider. Host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1102 is a cellular network that implements 3GPP standardized features. Accordingly, telecommunication network 1102 may support network slicing to provide different logical networks to different devices that are connected to telecommunication network 1102. For example, telecommunication network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1112 are configured to transmit and/or receive information without direct human interaction. For instance, a UE may be designed to transmit information to access network 1104 on a predetermined schedule, when triggered by an internal or external event, or in response to requests from access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1114 communicates with access network 1104 to facilitate indirect communication between one or more UEs (e.g., 1112c and/or 1112d) and network nodes (e.g., network node 1110b). In some examples, hub 1114 may be a controller, router, content source and analytics, or any of the other communication devices described herein regarding UEs. For example, hub 1114 may be a broadband router enabling access to core network 1106 for the UEs. As another example, hub 1114 may be a controller that sends commands or instructions to one or more actuators in the UEs. Commands or instructions may be received from the UEs, network nodes 1110, or by executable code, script, process, or other instructions in hub 1114. As another example, hub 1114 may be a data collector that acts as temporary storage for UE data and, in some embodiments, may perform analysis or other processing of the data. As another example, hub 1114 may be a content source. For example, for a UE that is a VR headset, display, loudspeaker or other media delivery device, hub 1114 may retrieve VR assets, video, audio, or other media or data related to sensory information via a network node, which hub 1114 then provides to the UE either directly, after performing local processing, and/or after adding additional local content. In still another example, hub 1114 acts as a proxy server or orchestrator for the UEs, in particular if one or more of the UEs are low energy IoT devices.

Hub 1114 may have a constant/persistent or intermittent connection to network node 1110b. Hub 1114 may also allow for a different communication scheme and/or schedule between hub 1114 and UEs (e.g., 1112c and/or 1112d), and between hub 1114 and core network 1106. In other examples, hub 1114 is connected to core network 1106 and/or one or more UEs via a wired connection. Moreover, hub 1114 may be configured to connect to an M2M service provider over access network 1104 and/or to another UE over a direct connection. In some scenarios, UEs may establish a wireless connection with network nodes 1110 while still connected via hub 1114 via a wired or wireless connection. In some embodiments, hub 1114 may be a dedicated hub-that is, a hub whose primary function is to route communications to/from the UEs from/to network node 1110b. In other embodiments, hub 1114 may be a non-dedicated hub-that is, a device which is capable of operating to route communications between the UEs and network node 1110b, but which is additionally capable of operating as a communication start and/or end point for certain data channels.

In some embodiments, one or more core network nodes 1108 can be configured to implement a DCCF, an NRF, and/or a service producer NF, such as being capable of performing operations attributed to these NFs in above descriptions of various methods or procedures in relation to FIGS. 6-10.

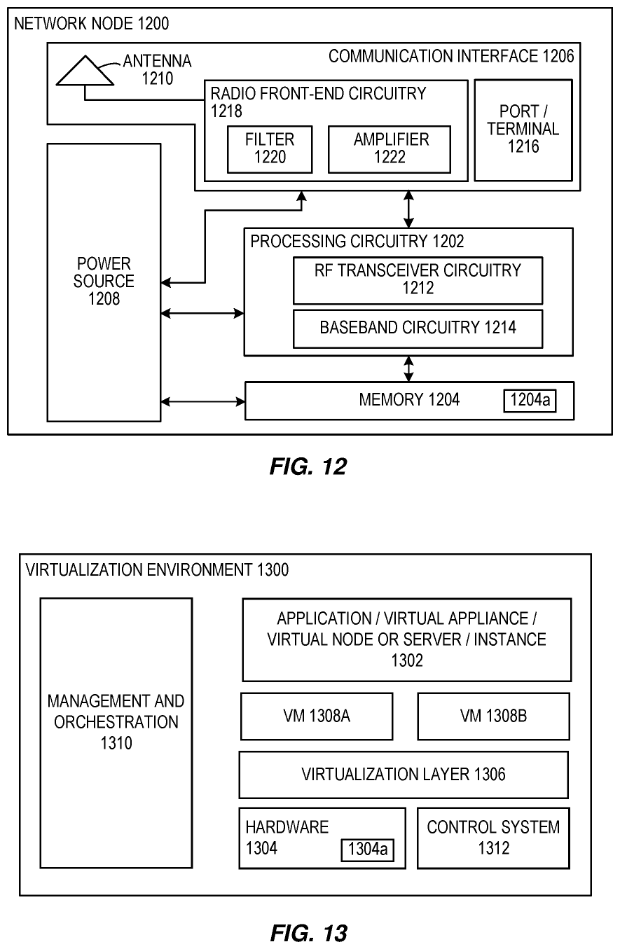

FIG. 12 shows a network node 1200 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes a processing circuitry 1202, a memory 1204, a communication interface 1206, and a power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. Memory 1204 may store any suitable instructions, data, or information, including a computer program, software, an application including one or more of logic, rules, code, tables, and/or other instructions (collected denoted computer program 1204a, which may be in the form of a computer program product) capable of being executed by the processing circuitry 1202 and utilized by network node 1200. Memory 1204 may be used to store any calculations made by the processing circuitry 1202 and/or any data received via communication interface 1206. In some embodiments, the processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to the processing circuitry 1202. In other embodiments, the communication interface may comprise different components and/or different combinations of components.

In certain alternative embodiments, network node 1200 does not include separate radio front-end circuitry 1218, instead, the processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or the processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

In some embodiments, one or more network nodes 1200 can be configured to implement a DCCF, an NRF, and/or a service producer NF, such as being capable of performing operations attributed to these NFs in above descriptions of various methods or procedures in relation to FIGS. 6-10.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1300 includes components defined by the O-RAN Alliance, such as an O-Cloud environment orchestrated by a Service Management and Orchestration Framework via an O-2 interface.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein. For example, in some embodiments, virtualization environment 1300 can host one or more virtual nodes or network functions 1302 that are configured to perform operations attributed to a DCCF, an NRF, and/or a service producer NF in above descriptions of various methods or procedures in relation to FIGS. 6-10.

Hardware 1304 includes processing circuitry, memory that stores software and/or instructions (collected denoted computer program 1304a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. Virtualization layer 1306 may present a virtual operating platform that appears like networking hardware to the VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1308 may be a software implementation of a physical machine that runs programs as if they were executing on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration function 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a data collection coordination function (DCCF) in a communication network, the method comprising:
   receiving, from a service consumer network function (NFc) of the communication network, a first service request for data produced by the communication network;
   determining a service producer network function (NFp), of the communication network, that produces the requested data;
   sending, to a network repository function (NRF) of the communication network, a request for a second access token granting the DCCF permission to access the data produced by the NFp on behalf of the NFc, wherein the request includes:
      a client credentials assertion (CCA) associated with one of the DCCF and the NFc, and
      an additional credentials assertion (ACA) associated with the other of the DCCF and the NFc;
   receiving the second access token from the NRF, wherein the second access token includes a subject claim identifying one of the DCCF and the NFc and an additional claim identifying the other of the DCCF and the NFc; and
   sending to the NFp a second service request for the data, wherein the second service request includes the second access token, the CCA, and the ACA.
A2. The method of embodiment A1, further comprising:
   receiving from the NFp a second service response that includes the data; and
   sending to the NFc a first service response that includes the received data.
A3. The method of any of embodiments A1-A2, wherein the first service request also includes a first CCA associated with the NFc.
A4. The method of embodiment A3, wherein:
   the CCA is associated with the DCCF and the ACA is associated with the NFc;
   the ACA includes the first CCA received in the first service request; and
   the subject claim identifies the DCCF and the additional claim identifies the NFc.
A5. The method of embodiment A3, wherein:
   the CCA is associated with the NFc and the ACA is associated with the DCCF;
   the CCA includes the first CCA received in the first service request; and
   the subject claim identifies the NFc and the additional claim identifies the DCCF.
A6 The method of any of embodiments A1-A5, wherein:
   the first service request includes a first access token granting the NFc permission to access the DCCF; and
   sending the request for the second access token is based on verifying the first access token.
A7. The method of any of embodiments A1-A6, wherein sending the request for the second access token is performed selectively according to one or more of the following: NRF support of authorization based on CCA and ACA, and local configuration of the DCCF.
A7a. The method of embodiment A7, further comprising, when sending the request for the second access token is not performed, performing a local authorization for the NFc to access the data produced by the NFp.
A8. The method of any of embodiments A1-A7a, wherein the NFc is a network data analytics function (NWDAF).
A9. The method of any of embodiments A1-A8, wherein:
   the ACA also includes a CCA associated with at least one additional NF; and
   the second access token also includes at least one further additional claim identifying the respective at least one additional NF.
B1. A method for a network repository function (NRF) of a communication network, the method comprising:
   receiving, from a data collection coordination function (DCCF) of the communication network, a second request for a second access token granting the DCCF permission to access, on behalf of a service consumer network function (NFc) of the communication network, data produced by a service producer network function (NFp) of the communication network, wherein the second request includes:
      a client credentials assertion (CCA) associated with one of the DCCF and the NFc, and
      an additional credentials assertion (ACA) associated with the other of the DCCF and the NFc;
   based on the CCA and ACA, verifying that the DCCF is authorized to access the data produced by the NFp on behalf of the NFc; and
   based on verifying that the DCCF is authorized to access the data on behalf of the NFc, generating the second access token and sending to the DCCF a second response that includes the second access token, wherein the second access token includes a subject claim identifying one of the DCCF and the NFc and an additional claim identifying the other of the DCCF and the NFc.
B2. The method of embodiment B1, further comprising:
   receiving from the NFc a first request for a first access token granting the NFc permission to access the DCCF; and
   based on verifying that the NFc is authorized to access the DCCF, generating the first access token and sending to the NFc a first response that includes the first access token.
B3. The method of any of embodiments B1-B2, wherein:
   the CCA is associated with the DCCF and the ACA is associated with the NFc;
   the ACA includes a first CCA associated with the NFc; and
   the subject claim identifies the DCCF and the additional claim identifies the NFc.
B4. The method of any of embodiments B1-B2, wherein:
   the CCA is associated with the NFc and the ACA is associated with the DCCF; and
   the subject claim identifies the NFc and the additional claim identifies the DCCF.
B5. The method of any of embodiments B1-B4, wherein the NFc is a network data analytics function (NWDAF).
B6. The method of any of embodiments B1-B5, wherein:
   the ACA also includes a CCA associated with at least one additional NF; and
   the second access token also includes at least one further additional claim identifying the respective at least one additional NF.
C1. A method for a service producer network function (NFp) of a communication network, the method comprising:
   receiving, from a data collection coordination function (DCCF) of the communication network, a second service request for data produced by the NFp, wherein:
      the second service request includes a second access token granting the DCCF permission to access the data on behalf of a service consumer network function (NFc) of the communication network, and
      the second access token includes a subject claim identifying one of the DCCF and the NFc and an additional claim identifying the other of the DCCF and the NFc; and
   verifying the second access token; and
   based on verifying the second access token, sending to the DCCF a service response that includes the data.
C2. The method of embodiment c1, wherein the second service request also includes the following:
   a client credentials assertion (CCA) associated with the one of the DCCF and the NFc, and
   an additional credentials assertion (ACA) associated with the other of the DCCF and the NFc.
C3. The method of embodiment C2, wherein verifying the second access token comprises verifying that the identification in the subject claim matches the CCA and that the identification in the additional claim matches the ACA.
C4. The method of any of embodiments C2-C3, wherein:
   the CCA is associated with the DCCF and the ACA is associated with the NFc;
   the ACA includes the first CCA received in the first service request; and
   the subject claim identifies the DCCF and the additional claim identifies the NFc.
C5. The method of any of embodiments C2-C3, wherein:
   the CCA is associated with the NFc and the ACA is associated with the DCCF;
   the CCA includes the first CCA received in the first service request; and
   the subject claim identifies the NFc and the additional claim identifies the DCCF.
C6. The method of any of embodiments C2-C5, wherein:
   the ACA also includes a CCA associated with at least one additional NF; and
   the second access token also includes at least one further additional claim identifying the respective at least one additional NF.
C7. The method of any of embodiments C1-C6, wherein the NFc is a network data analytics function (NWDAF).
D1. A data collection coordination function (DCCF) of a communication network, the DCCF comprising:
   interface circuitry configured to communicate with one or more service consumer network functions (NFs), one or more service producer NFs, and a network repository function (NRF) of the communication network; and
   processing circuitry operably coupled to the interface circuitry, whereby the processing circuitry and interface circuitry are configured to perform operations corresponding to any of the methods of embodiments A1-A9.
D2. A data collection coordination function (DCCF) of a communication network, the DCCF being configured to perform operations corresponding to any of the methods of embodiments A1-A9.
D3. A non-transitory, computer-readable medium storing computer-executable instructions that, when executed by processing circuitry associated with a data collection coordination function (DCCF) of a communication network, configure the DCCF to perform operations corresponding to any of the methods of embodiments A1-A9.
D4. A computer program product comprising computer-executable instructions that, when executed by processing circuitry associated with a data collection coordination function (DCCF) of a communication network, configure the DCCF to perform operations corresponding to any of the methods of embodiments A1-A9.
E1. A network repository function (NRF) of a communication network, the NRF comprising:
   interface circuitry configured to communicate with one or more service consumer network functions (NFs) and a data collection coordination function (DCCF) of the communication network; and
   processing circuitry operably coupled to the interface circuitry, whereby the processing circuitry and interface circuitry are configured to perform operations corresponding to any of the methods of embodiments B1-B6.
E2. A network repository function (NRF) of a communication network, the NRF being arranged to perform operations corresponding to any of the methods of embodiments B1-B6.
E3. A non-transitory, computer-readable medium storing computer-executable instructions that, when executed by processing circuitry associated with a network repository function (NRF) of a communication network, configure the NRF to perform operations corresponding to any of the methods of embodiments B1-B6.
E4. A computer program product comprising computer-executable instructions that, when executed by processing circuitry associated with a network repository function (NRF) of a communication network, configure the NRF to perform operations corresponding to any of the methods of embodiments B1-B6.
F1. A service producer network function (NF) of a communication network, the service producer NF comprising:
   interface circuitry configured to communicate with a data collection coordination function (DCCF) and one or more service consumer NFs of the communication network; and
   processing circuitry operably coupled to the interface circuitry, whereby the processing circuitry and interface circuitry are configured to perform operations corresponding to any of the methods of embodiments C1-C7.
F2. A service producer network function (NF) of a communication network, the service producer NF being configured to perform operations corresponding to any of the methods of embodiments C1-C7.
F3. A non-transitory, computer-readable medium storing computer-executable instructions that, when executed by processing circuitry associated with a service producer network function (NF) of a communication network, configure the service producer NF to perform operations corresponding to any of the methods of embodiments C1-C7.
F4. A computer program product comprising computer-executable instructions that, when executed by processing circuitry associated with a service producer network function (NF) of a communication network, configure the service producer NF to perform operations corresponding to any of the methods of embodiments C1-C7.

1.-41. (canceled)

42. A method for a data collection coordination function (DCCF) in a communication network, the method comprising:
receiving, from a service consumer network function (NFc) of the communication network, a first service request for data produced by the communication network;
determining a service producer network function (NFp), of the communication network, that produces the requested data;
sending, to a network repository function (NRF) of the communication network, a request for a second access token granting the DCCF permission to access the data produced by the NFp on behalf of the NFc, wherein the request includes:
a client credentials assertion (CCA) associated with one of the DCCF and the NFc, and
an additional credentials assertion (ACA) associated with the other of the DCCF and the NFc;
receiving the second access token from the NRF, wherein the second access token includes a subject claim identifying one of the DCCF and the NFc and an additional claim identifying the other of the DCCF and the NFc; and
sending to the NFp a second service request for the data, wherein the second service request includes the second access token, the CCA, and the ACA.

43. The method of claim 42, further comprising:
receiving from the NFp a second service response that includes the data; and
sending to the NFc a first service response that includes the received data.

44. The method of claim 42, wherein the first service request also includes a first CCA associated with the NFc.

45. The method of claim 44, wherein:
the CCA is associated with the DCCF and the ACA is associated with the NFc;
the ACA includes the first CCA received in the first service request; and
the subject claim identifies the DCCF and the additional claim identifies the NFc.

46. The method of claim 44, wherein:
the CCA is associated with the NFc and the ACA is associated with the DCCF;
the CCA includes the first CCA received in the first service request; and
the subject claim identifies the NFc and the additional claim identifies the DCCF.

47. The method of claim 42, wherein:
the first service request includes a first access token granting the NFc permission to access the DCCF; and
sending the request for the second access token is based on verifying the first access token.

48. The method of claim 42, wherein sending the request for the second access token is performed selectively according to one or more of the following: NRF support of authorization based on CCA and ACA, and local configuration of the DCCF.

49. The method of claim 48, further comprising, when sending the request for the second access token is not performed, performing a local authorization for the NFc to access the data produced by the NFp.

50. The method of claim 42, wherein the NFc is a network data analytics function (NWDAF).

51. The method of claim 42, wherein:
the ACA also includes a CCA associated with at least one additional NF; and
the second access token also includes at least one further additional claim identifying respectively the at least one additional NF.

52. A method for a network repository function (NRF) of a communication network, the method comprising:
receiving, from a data collection coordination function (DCCF) of the communication network, a second request for a second access token granting the DCCF permission to access, on behalf of a service consumer network function (NFc) of the communication network, data produced by a service producer network function (NFp) of the communication network, wherein the second request includes:
a client credentials assertion (CCA) associated with one of the DCCF and the NFc, and
an additional credentials assertion (ACA) associated with the other of the DCCF and the NFc;
based on the CCA and ACA, verifying that the DCCF is authorized to access the data produced by the NFp on behalf of the NFc; and
based on verifying that the DCCF is authorized to access the data on behalf of the NFc, generating the second access token and sending to the DCCF a second response that includes the second access token,
wherein the second access token includes a subject claim identifying one of the DCCF and the NFc and an additional claim identifying the other of the DCCF and the NFc.

53. The method of claim 52, further comprising:
receiving from the NFc a first request for a first access token granting the NFc permission to access the DCCF; and
based on verifying that the NFc is authorized to access the DCCF, generating the first access token and sending to the NFc a first response that includes the first access token.

54. The method of claim 52, wherein:
the CCA is associated with the DCCF and the ACA is associated with the NFc;
the ACA includes a first CCA associated with the NFc; and
the subject claim identifies the DCCF and the additional claim identifies the NFc.

55. The method of claim 52, wherein:
the CCA is associated with the NFc and the ACA is associated with the DCCF; and
the subject claim identifies the NFc and the additional claim identifies the DCCF.

56. The method of claim 52, wherein:
the ACA also includes a CCA associated with at least one additional NF; and
the second access token also includes at least one further additional claim identifying the respective at least one additional NF.

57. A method for a service producer network function (NFp) of a communication network, the method comprising:
receiving, from a data collection coordination function (DCCF) of the communication network, a second service request for data produced by the NFp, wherein:
the second service request includes a second access token granting the DCCF permission to access the data on behalf of a service consumer network function (NFc) of the communication network, and
the second access token includes a subject claim identifying one of the DCCF and the NFc and an additional claim identifying the other of the DCCF and the NFc; and
verifying the second access token; and
based on verifying the second access token, sending to the DCCF a service response that includes the data.

58. The method of claim 57, wherein the second service request also includes the following:
a client credentials assertion (CCA) associated with the one of the DCCF and the NFc, and
an additional credentials assertion (ACA) associated with the other of the DCCF and the NFc.

59. The method of claim 58, wherein verifying the second access token comprises verifying that the identification in the subject claim matches the CCA and that the identification in the additional claim matches the ACA.

60. The method of claim 58, wherein:
the CCA is associated with the DCCF and the ACA is associated with the NFc;
the ACA includes the first CCA received in the first service request; and
the subject claim identifies the DCCF and the additional claim identifies the NFc.

61. The method of claim 58, wherein:
the CCA is associated with the NFc and the ACA is associated with the DCCF;
the CCA includes the first CCA received in the first service request; and
the subject claim identifies the NFc and the additional claim identifies the DCCF.

62. The method of claim 58, wherein:
the ACA also includes a CCA associated with at least one additional NF; and
the second access token also includes at least one further additional claim identifying respectively the at least one additional NF.

63. Network equipment configured to implement a data collection coordination function (DCCF) of a communication network, the network equipment comprising communication interface circuitry and processing circuitry that are operably coupled and configured to perform the method of claim 42.

64. Network equipment configured to implement a network repository function (NRF) of a communication network, the network equipment comprising communication interface circuitry and processing circuitry that are operably coupled and configured to perform the method of claim 52.

65. Network equipment configured to implement a service producer network function (NFp) of a communication network, the network equipment comprising communication interface circuitry and processing circuitry that are operably coupled and configured to perform the method of claim 57.
